(19) United States
(12) Patent Application Publication
(10) Pub. No.: US 2013/0335263 A1
(43) Pub. Date: Dec. 19, 2013

(54) METHOD AND DEVICE FOR DETERMINING THE POSITION OF A VEHICLE

(71) Applicant: Siemens Aktiengsellschaft, Muenchen (DE)

(72) Inventor: REINER SCHMID, MUENCHEN (DE)

(21) Appl. No.: 13/916,771

(22) Filed: Jun. 13, 2013

(30) Foreign Application Priority Data
Jun. 13, 2012 (DE) 10 2012 209 873.9

(51) Int. Cl. G01S 19/41

(52) U.S. Cl. CPC G01S 19/41
USPC 342/357.24

(57) ABSTRACT

A method determines a position of a vehicle. The method includes providing first raw position data from a satellite navigation system pertaining to the vehicle. At least one further vehicle is identified and a communication link is set up to the at least one further vehicle. Second raw position data of the satellite navigation system of the at least one further vehicle is received by way of the established communication link. The position of the vehicle is calculated by differential positioning based on the received second raw position data of the at least one further vehicle and on the first raw position data of the vehicle.

### CROSS-REFERENCE TO RELATED APPLICATION

This application claims the priority, under 35 U.S.C. §119, of German application DE 10 2012 209 873.9, filed Jun. 13, 2012; the prior application is herewith incorporated by reference in its entirety.

### BACKGROUND OF THE INVENTION

### Field of the Invention

The present invention relates to a method and a device for determining a position of a vehicle.

Modern-day automobiles are equipped to an increasing extent with means of communication which allow an exchange of data between automobiles while on the move, referred to as Car-to-Car communication.

Car-to-car communication—also known in the English-speaking world as vehicle-to-vehicle communication, or V2V for short—refers to the exchange of information and data between motor vehicles against the background of alerting the driver at an early stage to critical and dangerous situations. Toward that end there are various ongoing projects in Europe aimed at increasing safety in traffic as well as optimizing the flow of traffic.

With such a system it is possible for example to transmit data relating to speed, travel direction and destination, but also to road conditions and the traffic situation.

A prerequisite for enabling the receiving vehicle to conduct an optimally meaningful evaluation is the precise determination of at least the relative position of the transmitting vehicle with respect to the receiver. With the currently established methods of determining position, such as a global positioning system, GPS for short, officially NAVSTAR GPS, a global navigation satellite system for position determination, this position often cannot, however, be ascertained with sufficient accuracy, that is to say with a precision in the centimeter range.

If this is ensured, however, the transmitted data can be evaluated much better with regard to the prevailing traffic situation. Furthermore the association between transmitter data and transmitter position is required, and this must also be guaranteed even given high vehicle densities.

### SUMMARY OF THE INVENTION

It is therefore an object of the present invention to provide a combination of car-to-car communication with the raw, unprocessed GPS receiver data in order to enable an infrastructureless exact determination of the relative position of the vehicles with respect to one another.

The invention relates to a method for determining the position of a vehicle. The method includes providing first raw position data of a satellite navigation system of the vehicle. At least one further vehicle is identified and a communication link is set up to the identified at least one further vehicle. Second raw position data of the satellite navigation system of the at least one further vehicle is received by way of the established communication link. The position of the vehicle is calculated by differential positioning based on the received second raw position data of the at least one further vehicle and on the provided first raw position data of the vehicle.

According to a further aspect the present invention provides a device for determining the position of a vehicle. The device contains a data storage unit which is configured for providing raw position data of a satellite navigation system of the vehicle and an image sensor unit which is configured for identifying at least one further vehicle. The device further has a communication unit which is configured for identifying the at least one further vehicle and setting up a communication link to the identified at least one further vehicle and for receiving raw data of the satellite navigation system of the at least one further vehicle by way of the established communication link. A computing unit is provided and is configured for calculating the position of the vehicle by use of differential positioning based on the received raw data of the at least one further vehicle and on the provided raw data of the vehicle.

The knowledge underlying the present invention consists in the recognition that data relating to the prevailing traffic situation, obstructions and the like can only be utilized to the full extent through a combination of car-to-car communication with the raw, unprocessed GPS receiver data.

The idea on which the present invention is based therefore consists in enabling information that is exchanged by way of car-to-car communication to be evaluated more effectively by the disclosed method in terms of its significance for the receiving vehicle.

Toward that end the present invention makes provision for assessing information sent by a nearby car in relation to an obstacle on a traffic lane for the purpose of ascertaining whether the information relates to the same traffic lane as that of the receiving car, and also whether this danger point is possibly not at all relevant to the receiving car because the latter has already left it behind.

The relative positioning permits information exchanged by way of car-to-car communication to be correctly interpreted. As a result the information can be evaluated in terms of its relevance to the receiving vehicle.

The identification of the sender, for example based on analysis of a video image recorded by the image sensor unit, enables the car-to-car communication to be correlated with other information that can be acquired by the receiving vehicle and permits its inclusion in the assessment of the driving situation.

The present invention also makes provision for warning information in relation to an obstruction from another vehicle to be correlated with the behavior of the other vehicle as observed by the image sensor unit, such as, say, a recognizable obstacle avoidance maneuver or braking behavior. It is furthermore possible to take account of the environment in the form of an environment model and thereby infer possible behavior patterns, thus facilitating the analysis of the relevance to the receiving vehicle.

In a possible embodiment variant of the method according to the invention it is provided that determining the position of the vehicle also includes creating an environment model which has a calculated position of the vehicle and a calculated position of the at least one further vehicle.

In another possible embodiment variant of the method according to the invention it is provided that the environment model is created as a result of a determination of the position of the vehicle based on image data of an image sensor unit.

In another possible embodiment variant of the method according to the invention it is provided that the determination of the position of the vehicle based on image data of the image sensor unit is accomplished by stereometric positioning.

In another possible embodiment variant of the method according to the invention it is provided that the position of the vehicle is determined by aligning the position of the vehicle with the created environment model.

In another possible embodiment variant of the method according to the invention it is provided that mapping information is incorporated into the environment model.

In another possible embodiment variant of the device according to the invention it is provided that information relating to a section of road traveled by the vehicle and/or traffic signs identified by image recognition is used as the incorporated mapping information.

In another possible embodiment variant of the device according to the invention it is provided that the environment model is created based on data from traffic monitoring equipment external to the vehicle.

In another possible embodiment variant of the device according to the invention it is provided that the environment model includes warning information from the at least one further vehicle.

The above embodiments and developments can be combined with one another as desired insofar as this is beneficial. Other possible embodiments, developments and implementations of the invention also include combinations, not explicitly cited, of features of the invention that have been described previously or will be described hereinbelow with reference to the exemplary embodiments.

Other features which are considered as characteristic for the invention are set forth in the appended claims.

Although the invention is illustrated and described herein as embodied in a method and a device for determining the position of a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a traffic situation containing three vehicles according to a possible embodiment variant of the method according to the invention;

FIG. 2 is a block diagram for creating an environment model for determining a position of a vehicle according to a possible embodiment variant of the inventive method;

FIG. 3 is a diagram of a device for determining the position of the vehicle according to a further embodiment variant of the inventive device; and

FIG. 4 is a flowchart of the method for determining the position of the vehicle according to an embodiment variant of the inventive method.

### DESCRIPTION OF THE INVENTION

In all the figures, unless expressly stated otherwise, like or functionally identical elements and devices have been labeled with the same reference signs.

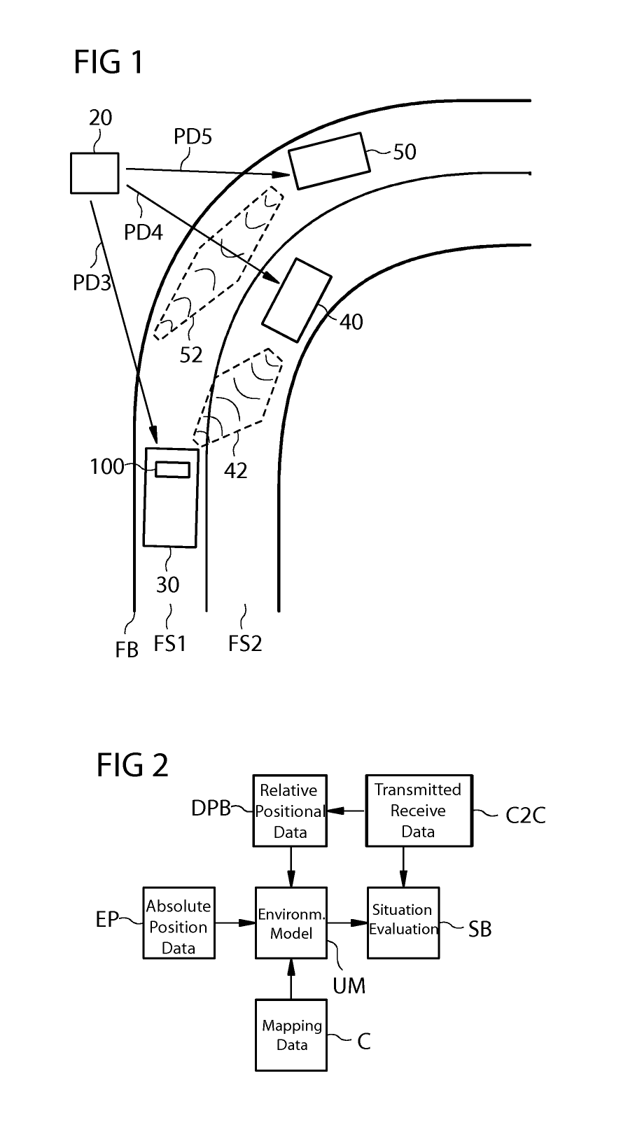

Referring now to the figures of the drawing in detail and first, particularly, to FIG. 1 thereof, there is shown a schematic view of a traffic situation containing three vehicles according to an embodiment variant of the inventive method.

A road FB contains a first lane FS1 and a second lane FS2. A vehicle 30 and a further vehicle 40 are located in the first lane, while another vehicle 50 is located in the second lane.

The vehicle 30 can set up communication links 42, 52 to the further vehicles 40, 50 for example by way of a communication unit 106 of a device 100.

The vehicle 30 is able to receive second raw position data PD4, PD5 of a satellite navigation system 20 by way of the communication links 42, 52, which data is provided for determining a position of the further vehicles 40, 50.

First raw position data PD3 of the satellite navigation system 20 of the vehicle 30 is transmitted for example by the satellite navigation system 20 to the vehicle 30.

FIG. 2 shows a schematic block diagram for creating an environment model for determining the position of the vehicle according to the inventive method.

An environment model UM in this case processes absolute position data EP relating to a vehicle's own position and relative position data DPB for the purpose of relative position determination.

The relative position data DPB for the purpose of relative position determination can be based for example on transmitted receive data C2CI which has been received by the vehicle 30 by way of the communication links 42, 52.

In order to create the environment model UM, mapping data C is additionally processed by a computing unit 108 of the vehicle 30.

Based on the environment model UM and the transmitted receive data C2CI, the computing unit 108 of the vehicle 30 furthermore computes a situation evaluation SB for the vehicle 30 and its environment.

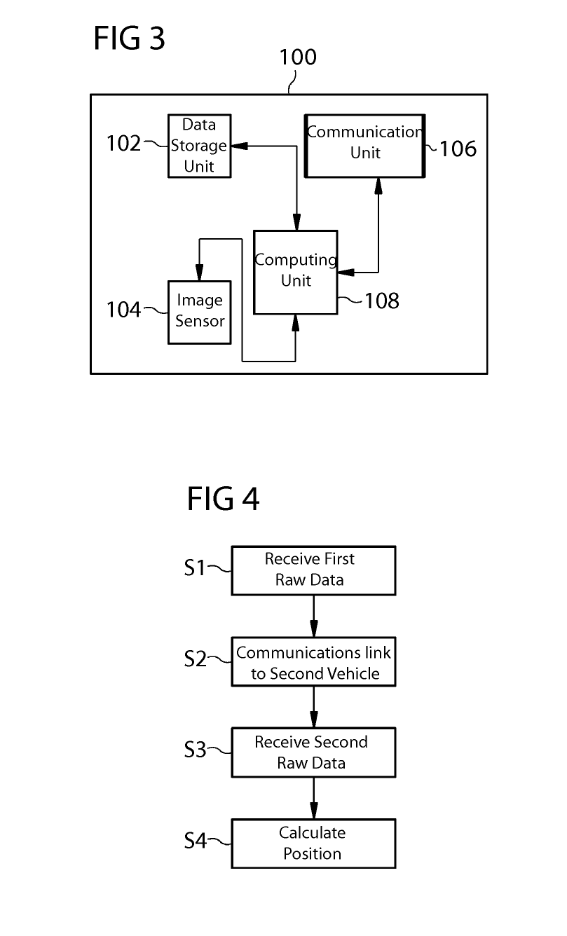

FIG. 3 shows a diagram of a device for determining the position of a vehicle according to a possible embodiment variant of the inventive device.

A device 100 for determining the position of a vehicle contains a data storage unit 102, an image sensor unit 104, a communication unit 106, and a computing unit 108.

The data storage unit 102 is configured for providing raw position data PD3 of a satellite navigation system 20 of the vehicle 30.

The image sensor unit 104 is configured for identifying at least one further vehicle 40, 50 in the vicinity of the vehicle 30.

The communication unit 106 is configured for setting up a communication link 42, 52 to the identified at least one further vehicle 40, 50 and for receiving raw data of the satellite navigation system 20 of the at least one further vehicle 40, 50 by way of the established communication link 42, 52.

The computing unit 108 is configured for establishing the position of the vehicle 30 by differential positioning based on the received raw data of the at least one further vehicle 40, 50 and on the provided first raw position data PD3 of the vehicle 30.

FIG. 4 shows a flowchart of a method for determining the position of a vehicle according to a possible embodiment variant of the inventive method.

In a first step, first raw position data PD3 of a satellite navigation system 20 of the vehicle 30 is provided S1.

In a second step, at least one further vehicle 40, 50 is identified S2 and a communication link 42, 52 is set up to the identified at least one further vehicle 40, 50.

In a third step, second raw position data PD4, PD5 of the satellite navigation system 20 of the at least one further vehicle 40, 50 is received S3 by way of the established communication link 42, 52.

In a fourth step, the position of the vehicle 30 is calculated S4 by differential positioning based on the received raw position data PD4, PD5 of the at least one further vehicle and on the provided raw position data PD3 of the vehicle.

In differential positioning, corrections for the measured variables of the position of the vehicle 30 in relation to the individual satellites can be derived in this case from the raw position data of the further vehicles 40, 50 with known positions in order to reduce the systematically acting errors contained therein. Accordingly, the availability of the correction data detached from the reference station of the user's own vehicle 30 is important for a user so that he/she can correct his/her position.

Although the present invention has been described hereintofore with reference to preferred exemplary embodiments, it is not limited thereto, but can be modified in a multiplicity of different ways. In particular the invention can be varied or modified in manifold ways without departing from the core teachings of the invention.

1. A method for determining a position of a vehicle, which comprises the steps of:
providing first raw position data from a satellite navigation system pertaining to the vehicle;
identifying at least one further vehicle and setting up a communication link to the at least one further vehicle;
receiving second raw position data from the satellite navigation system pertaining to the at least one further vehicle by way of the communication link; and
calculating the position of the vehicle by means of differential positioning based on the second raw position data of the at least one further vehicle and on the first raw position data of the vehicle.

2. The method according to claim 1, which further comprises determining the position of the vehicle by additionally creating an environment model which has a calculated position of the vehicle and a calculated position of the at least one further vehicle.

3. The method according to claim 2, which further comprises creating the environment model by means of a determination of the position of the vehicle based on image data from an image sensor unit.

4. The method according to claim 3, which further comprises accomplishing the determination of the position of the vehicle based on the image data of the image sensor unit by means of stereometric positioning.

5. The method according to claim 2, which further comprises determining the position of the vehicle based on an alignment of the position of the vehicle with the environment model.

6. The method according to claim 2, wherein the environment model includes incorporating mapping data.

7. The method according to claim 6, which further comprises using information relating to at least one of a road section traveled by the vehicle or to traffic signs identified by means of image recognition as the mapping data.

8. The method according to claim 2, which further comprises creating the environment model on a basis of data acquired by traffic monitoring equipment external to the vehicle.

9. The method according to claim 1, wherein the environment model includes warning information from the at least one further vehicle.

10. A device for determining a position of a vehicle, the device comprising:
a data storage unit for providing first raw position data from a satellite navigation system pertaining to the vehicle;
an image sensor unit for identifying at least one further vehicle;
a communication unit for setting up a communication link to the at least one further vehicle and for receiving second raw position data from the satellite navigation system pertaining to the at least one further vehicle by way of the communication link; and
a computing unit for calculating the position of the vehicle by differential positioning based on the second raw data of the at least one further vehicle and on the first raw data of the vehicle.
